(19) United States
(12) Patent Application Publication
(10) Pub. No.: US 2006/0075761 A1
(43) Pub. Date: Apr. 13, 2006

(54) Apparatus for cooled or heated on demand drinking water and process for making same

(76) Inventors: Mark Charles Kitchens, Athens, TX (US); Regis Marie-Jean Wandres, Athens, TX (US); John Chiu, Taipei (TW)

Correspondence Address: MARK KITCHENS, 1107 BEL AIR, ATHENS, TX, 75751, US

(21) Appl. No.: 10/960,257

(22) Filed: Oct. 7, 2004

(51) Int. Cl. F25B 21/02; B67D 5/62

(52) U.S. Cl. 62/3.64; 62/3.3; 62/389

(57) ABSTRACT

An apparatus for Cooled Or Heated On Demand Drinking Water having a thermal accumulator with embedded serpentine fluid conduit, a network of independently controlled thermoelectric heat transfer modules, and a network of temperature control modules. A preferred embodiment includes the thermal accumulator as a single die-cast thermally conductive metallic medium free of seams and an embedded pipe free of coupling structure.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of thermoelectric coolers and more specifically to an apparatus for Cooled Or Heated On Demand Drinking Water and process for making same.

The present invention relates to the general field of thermoelectric fluid temperature control, more particularly, to a pressurized in-line water cooling or heating device. The consumer's market in today's society increasingly favors water at cool temperatures. There have been many inventions and products on the market to address this demand. Usually, such products involve water supply, reservoir, cooling or heating device, and plumbing parts to interconnect the various elements of water cooling products. Also widely available on today's consumer market are thermoelectric devices that rely on the Peltier effect to control the temperature of fluids.

Previous inventions describe various methods to provide cooled or heated water. U.S. Pat. No. 6,644,037 B2 describes a thermoelectric beverage cooler where water is stored in a reservoir that is manually refilled when empty. A single thermoelectric assembly cools the water via thermal conduction through the reservoir.

U.S. Pat. No. 6,508,070 B1 describes a thermoelectric water chiller where water is also store in a reservoir but where the reservoir is pressurized and automatically refilled when water is drawn from the tank. A single thermoelectric assembly cools the water via direct contact with the water.

Another type of water cooler is described in U.S. Pat. No. 5,072,590 where water supply is an exchangeable water bottle and water is pumped through a heat exchanger. U.S. Pat. No. 4,996,847 describes a similar method to cool water. Some inventions describe enhanced cooling capabilities using various types of cooling manifolds sometimes in combination with high-power thermoelectric assemblies. U.S. Pat. No. 4,829,771 and U.S. Pat. No. 5,493,864 are examples of such inventions. Some similar inventions sometimes apply to fluid cooling other than for human liquid consumption. U.S. Pat. No. 6,502,405 describes a fluid cooling method for an automotive application.

There is also a large availability of water cooling or heating devices that do not use thermoelectric devices but share the same methods of storing, delivering water.

Most prior art in this field of application are prone to leakage due to design shortcomings, aging, and misuse. Whether the prior art is a manually or automatically refilled system, it almost always involves some plumbing elements and reservoir. In U.S. Pat. No. 6,644,037 B2 water is stored in a reservoir that is manually refilled from the top opening and where water is drawn through a water spigot. The water spigot assembly protrudes through the reservoir. O-rings seal the reservoir. O-ring can age, or be installed improperly, such system are always prone to possible leak. U.S. Pat. No. 6,508,070 B1 does present the advantage of continuous water supply as it is refilled by the common household plumbed-in fresh water supply but is extremely prone to leaks. Water enters and exits the reservoir via piping that enters the reservoir, the thermoelectric cooling element also enters through the reservoir. Seals are used to render the assembly water sealed but a possible seal failure can prove very possible and destructive due to this is a pressurized system with a potential continuous flow of water. Being pressurized and within a household plumbed-in system, if the system is placed after a water-pressure control device, the entire thermoelectric device could explode or certainly leak in case of freezing ambient conditions. This is a critical inherent design flaw that has hindered the full commercial success of such inventions. Other pressurized or non-pressurized thermoelectric fluid coolers rely on a cooling system separate from the water supply reservoir such as invention described in U.S. Pat. No. 5,072,590 but the use of a pump to circulate water also increases the risk of leak. Other examples of water cooling separate than from the supply reservoir are described in U.S. Pat. No. 5,493,864 and U.S. Pat. No. 6,502,405 B1 where water is cooled in a manifold. Such manifold is less prone to leak, although the entire system is still prone to leak through other elements of these inventions. The present invention eliminates all types of leak risk by eliminating all sealed connections, the present invention uses a single continuous pipe to refill, store, cool, and provide cooled water.

Although thermoelectric coolers are environmentally friendly, safer to use, and of simpler construction than their compressor or gas absorption counterparts, thermoelectric coolers always suffer from a lack of performance. The typical thermoelectric cooler can only cool a small amount of water at the time and requires long pre-cooling of water before they can be used at optimum performance. For example, U.S. Pat. No. 5,072,590 or U.S. Pat. No. 6,508,070 B1 or U.S. Pat. No. 6,644,037 B2 all have cooling capacity according to the volume of their reservoir and require several hours of wait time to cool ambient temperature water to desirable temperature for consumption. U.S. Pat. No. 4,829,771 has an increased cooling capacity but requires great amount of power as it uses many thermoelectric elements. High current applications are not safe to use in household wet environment such as under sink cabinets. U.S. Pat. No. 5,493,864 combines multiple thermoelectric elements with an improved heat exchange manifold to significantly reduce pre-cooling time, but cannot deliver a continuous, uninterrupted supply of cooled water without the use of increased power or leak-prone connections, and is very complicated to manufacture. U.S. Pat. No. 4,634,803 and U.S. Pat. No. 5,561,981 also describe inventions that could potentially deliver continuous supply of cooled water but are either prone to leak and complicated manufacture due to their heat exchanger design, and require high power to rapidly cool water to desirable level. The present invention addresses all the previously mentioned short-comings as the device is low power, does not require pre-cooling time, can provide cooled water continuously, is not prone to leak by design, and is very easy to manufacture.

### BRIEF SUMMARY OF THE INVENTION

The primary object of the invention is to provide an efficient practical apparatus of simple construction which provides cooled or heated drinking water.

Another object of the invention is to provide an efficient practical apparatus of simple construction which provides a non-specified and variable amount of cooled or heated drinking water.

Another object of the invention is to provide an efficient practical apparatus of simple construction which provides cooled or heated water at desired temperature with no wait time and no recovery time.

A further object of the invention is to provide an efficient practical apparatus of simple construction which does not require a fluid storage vessel.

Yet another object of the invention is to provide an efficient practical apparatus of simple construction which is compatible with common household fresh water plumbing.

Still yet another object of the invention is to provide an efficient practical apparatus of simple construction which provides cooled or heated drinking water with no need for gravity dispensing mean or pump dispensing mean.

Another object of the invention is to provide an efficient practical apparatus of simple construction which is not predisposed to internal leaks.

Another object of the invention is to provide a method which efficiently cools or heats drinking water.

A further object of the invention is to provide an efficient practical apparatus of simple construction and method which is immune to freezing ambient conditions.

Yet another object of the invention is to provide an efficient practical apparatus of simple construction and method which provides continuous usage with no regular maintenance and no indispensable servicing.

Still yet another object of the invention is to provide an efficient practical apparatus of simple construction and method which is compact in size.

Another object of the invention is to provide an efficient practical apparatus of simple construction and method which does not have a baneful influence on the environment.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for Cooled Or Heated On Demand Drinking Water comprising: a thermal accumulator with embedded serpentine fluid conduit, a network of independently controlled thermoelectric heat transfer modules, and a network of temperature control modules.

In accordance with a preferred embodiment of the invention, there is disclosed a process for An apparatus for Cooled Or Heated On Demand Drinking Water comprising: a thermal accumulator with embedded serpentine fluid conduit, a network of independently controlled thermoelectric heat transfer modules, and a network of temperature control modules.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded perspective view of the thermal accumulator of the invention.

FIG. 3 is a perspective view of the network of independently controlled heat transfer modules.

FIG. 4 is another perspective view of the network of independently controlled heat transfer modules.

FIG. 5 is a plan side view of the invention.

FIG. 6 is a perspective view of the embedded serpentine fluid conduit.

FIG. 7 is a plan top see-through view of a portion of the thermal accumulator.

FIG. 8 is a plan side see-through view of a portion of the thermal accumulator.

FIG. 9 is a plan top see-through assembly view of a portion of thermal accumulator and a portion of heat transfer modules.

FIG. 10 is a schematic block diagram of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

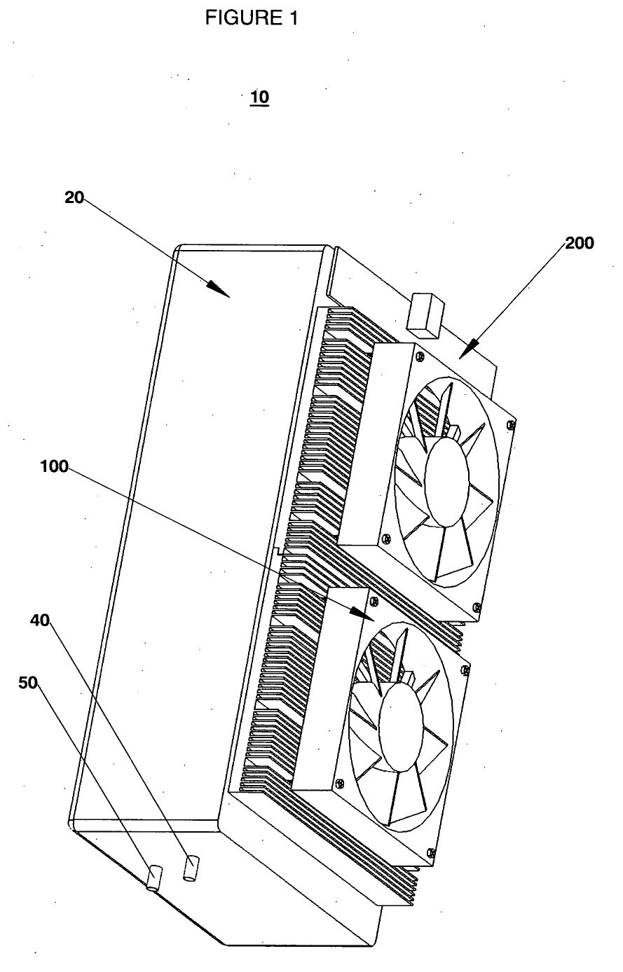

Turning first to FIG. 1, there is shown a perspective view of the present invention 10. In this preferred embodiment of the present invention 10, the apparatus can be called an Under the Counter Water Cooler (UCWC). For simplified detailed description of the present invention 10, elements that renders the invention marketable (such as cabinets, securing screws, power supply, connecting cables, and so on) are not represented in this FIG. 1.

FIG. 1 shows the three main elements of the present invention 10: the thermal accumulator 20 with embedded serpentine fluid conduit 30; the network of independently controlled thermoelectric heat transfer modules 100; and the network of temperature control modules 200. Also seen on FIG. 1 are the Inlet 40 and Outlet 50 of the embedded serpentine fluid conduit 30 (serpentine fluid conduit 30 is not visible in FIG. 1 except its Inlet 40 and Outlet 50). In accordance with an important claim of the present invention 10, this view demonstrates how the serpentine fluid conduit 30 is fully embedded within the thermal accumulator 20.

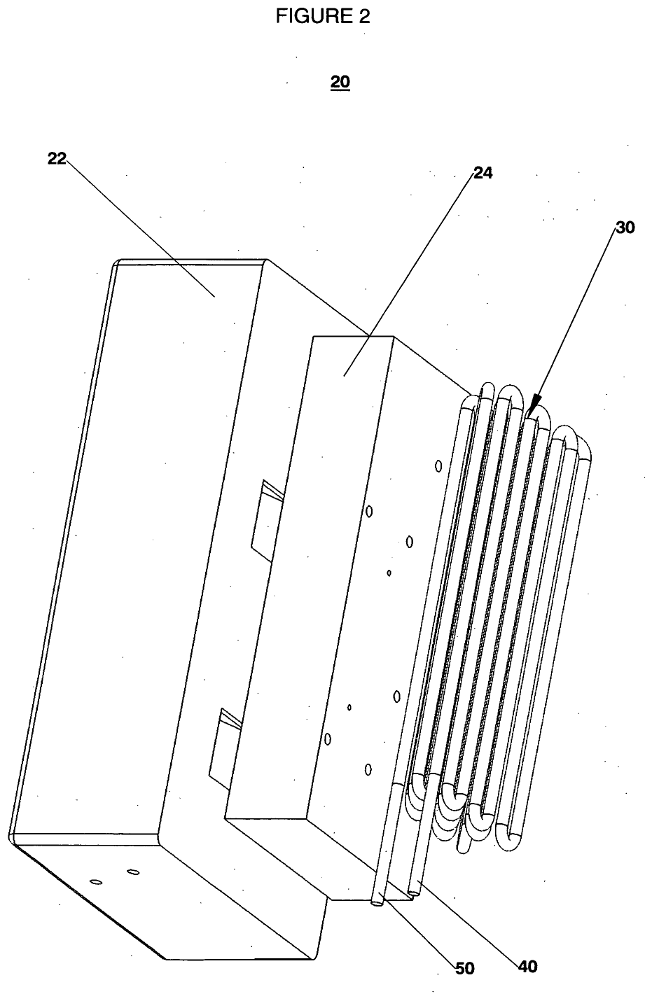

Now turning to FIG. 2, there is shown an exploded perspective view of the thermal accumulator 20. In accordance with an important claim of the present invention 10, the Thermal accumulator 20 consists of three elements. First element is a thermally non-conductive insulating medium 22. In a preferred commercial embodiment, insulating medium 22 can consist of polyurethane foam (PU), expanded polyethylene foam (EPE), or other similar commonly used thermal insulators. In accordance with an important claim of the present invention 10, insulating medium 22 shall completely shroud all other elements of the thermal accumulator 20 other than surfaces in thermal contact with the independently controlled thermoelectric heat transfer modules 100.

The second element of thermal accumulator 20 is the thermally conductive metallic medium 24. In accordance with an important claim of the present invention 10, thermally conductive metallic medium 24 shall be made of a single, die-cast, metallic material. In a preferred embodiment of the present invention 10, the thermally conductive metallic medium 24 can consist of die-cast aluminum, die-cast copper, or other metallic materials having a significant heat transfer ratio. In a preferred embodiment, thermally conductive metallic medium 24 shall consist of metallic materials having a conductivity of a least 50 W/m-K. For example, aluminum, steel, copper, silver, gold, tin are suitable materials, where stainless steel is not. Thermally conductive metallic medium 24 must be manufactured using a die-cast process which produces a single element, free of seams and separations, this, in accordance With an important claim of the present invention 10.

The third element of thermal accumulator 20 is the embedded serpentine fluid conduit 30. In accordance with an important feature of the present invention 10, the embedded serpentine fluid conduit 30 is a single continuous thermally conductive metallic pipe, in essence, it is manufactured as a single piece without coupling means such as fittings, connections, valves. In a preferred commercial embodiment, and in accordance with an important aspect of the present invention 10, the extremities of the embedded serpentine fluid conduit 30 are the Inlet 40 and outlet 50. Additionally, in accordance with a claim of the present invention 10, serpentine fluid conduit 30 is made of metallic material suitable and save for use with human liquid consumption such as, for example, stainless steel or copper.

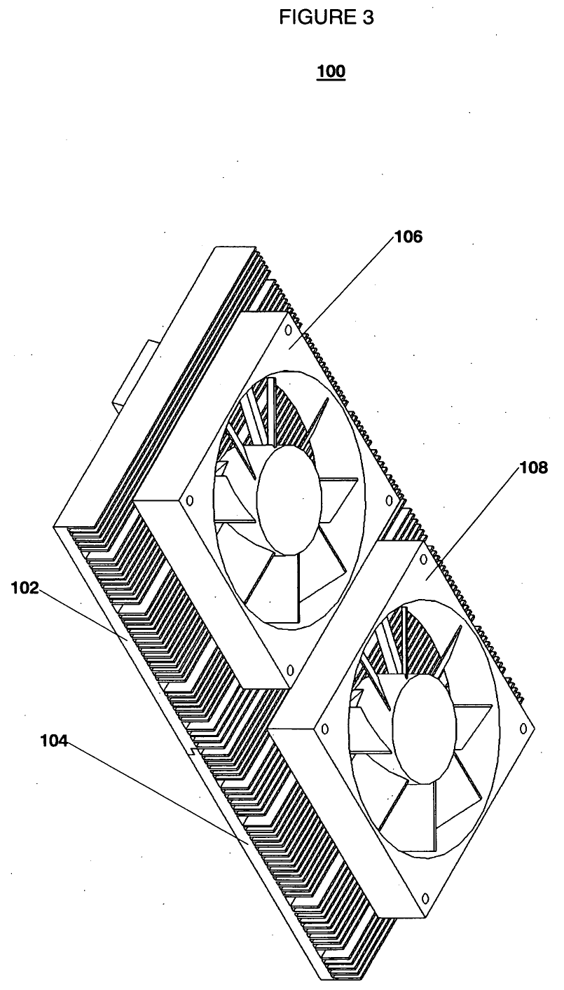

Turning to FIG. 3, there is shown a perspective view of the network of independently controlled thermoelectric heat transfer modules 100. This figure shows the assembly from a viewing plane above the present invention 10, opposite side of the thermal accumulator 20. Securing means such as screws and thermal accumulator 20, as well as wiring are not shown in this view for clarity. In this preferred embodiment the “hot” side of heat transfer modules 100 can consist of, but not limited to in material and quantity, two aluminum heat sinks 102 and 104. As in any thermoelectric solid state heat pumping systems, heat sinks 102 and 104 shall be of sufficient mass and of adequate shape to efficiently absorb and evacuate the heat load generated by the heat transfer modules 100. In this preferred embodiment, box-type fans 106 and 108 help heat sinks 102 and 104 evacuate the heat load. The invention is not limited to a particular type or quantity of fans.

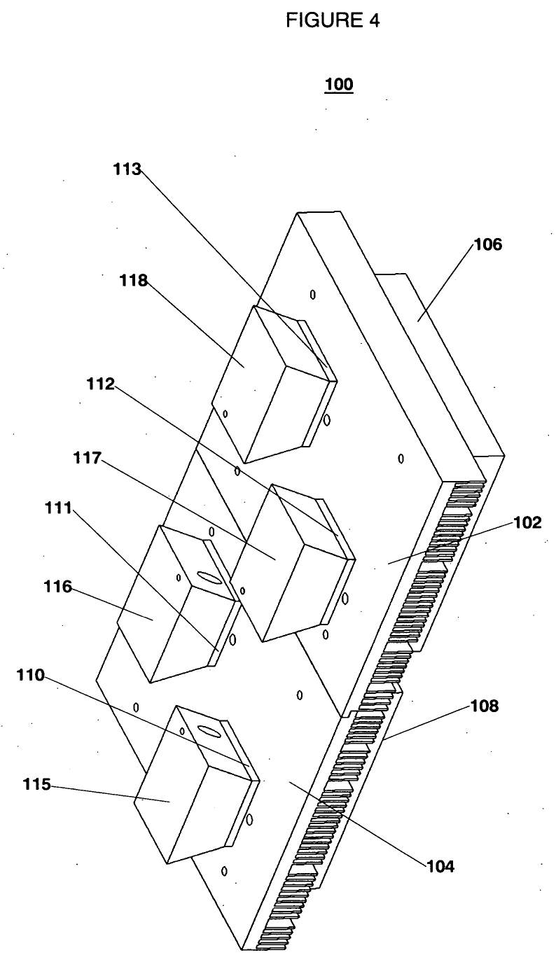

Further details of the heat transfer modules 100 are on FIG. 4. FIG. 4 shows a perspective view of the heat transfer modules 100. This figure shows the assembly from a viewing plane below the present invention 10, same side as the thermal accumulator 20, securing means such as screws and thermal accumulator 20 as well as electrical wiring are not shown in this view for clarity. In this preferred embodiment, FIG. 4 shows heat sinks 102 and 104, Box-type fans 106 and 108. In accordance with a claim of the present invention 10, thermoelectric Peltier elements 110˜113 are independent, meaning they are electrically connected via independent wiring. The preferred embodiment uses, but not limited to, 4 thermoelectric Peltier elements. These elements actively transfer heat from one side of the heat transfer modules 100 to its other side. Last elements of the heat transfer module 100 are the cold block spacers 115˜118. In an important aspect of the present invention 10, the positioning and size of the cold block spacer 115˜118 and Peltier element 110˜113 is critical to achieve a claim of the present invention. This aspect is detailed further in this detailed description. In accordance with a claim of this present invention, the surfaces of the cold block spacers 115˜118 facing the thermal accumulator 20 (bottom surface as shown in FIG. 4) are in physical contact with exposed outer surfaces of thermally conductive metallic medium 24.

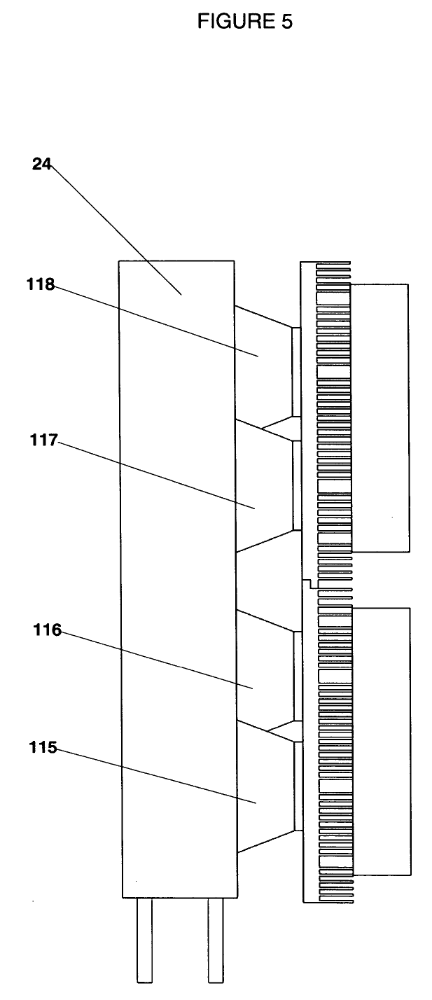

FIG. 5 is a side view of the present invention 10 with the insulating medium 22 not shown. FIG. 5 shows how the cold block spacers 115˜118 contact the exposed surface of metallic medium 24.

Turning back to FIG. 1 there is shown the network of temperature control module 200. Network of temperature control module 200 is an electronic circuit assembly that is electrically connected to the independently controlled heat transfer modules 100 and monitors the temperatures of independently controlled heat transfer modules 100. The detailed working of this aspect of the present invention is explained further in this detailed description.

In accordance with the principal claim of the present invention 10. The UCWC provides cooled or heated on demand drinking water. In this detailed explanation, we will only focus on the operation and process of the UCWC device in a cooling mode. The process is simply reversed for operation in heating mode. In this present invention 10 the term “on demand” connotes a readily cooled or heated fresh water supply, free of quantity limitations during use and free of recovery time between uses. Recovery time describes a time span necessary for the apparatus to cool or heat water at the desirable temperature. To fulfill this claim of the invention, the apparatus uses the following method:

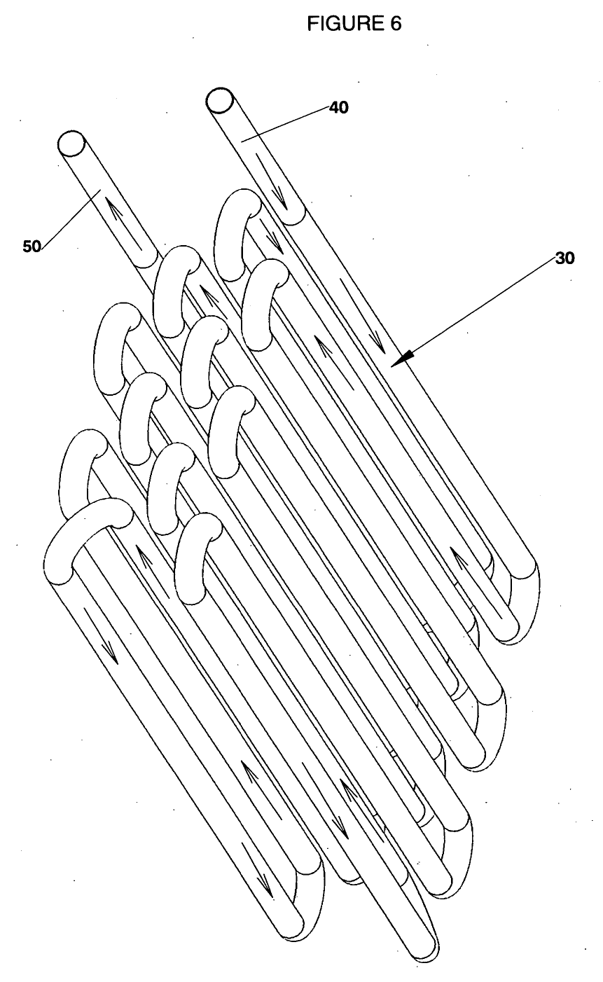

Turning to FIG. 6 there is shown a perspective view of the embedded serpentine fluid conduit 30, its Inlet 40 and Outlet 50. Fresh water is present inside embedded serpentine fluid conduit 30 at all times. Water is stagnant when the device is not in use, water flows during use as shown by the arrows in FIG. 6. In this preferred embodiment, the embedded serpentine fluid conduit 30 is a stainless steel grade 300 pipe with an outside diameter (O.D.) of a ¼ inch, the apparatus is compatible with common household plumbing system. In accordance with an important aspect of the present invention 10, the diameter of serpentine fluid conduit 30 has a direct effect on its length, geometry, and other elements of the apparatus. Serpentine fluid conduit 30 is maintained at a set temperature (this process explained further) and cools the water it contains by direct thermal contact. Taking in consideration a common household plumbing system's pressure and pipe dimensions, we can estimate a flow rate of about 1.5 gallon per minute (gpm). This flow rate, when circulating in a ¼ inch pipe, translates into the velocity equation of water within the embedded serpentine fluid conduit 30:
Velocity=(4×flow rate/1000)/(pi×(pipe O.D./1000)2)
Where Velocity is expressed in foot-per-second (ft/s), flow rate in gallon-per-minute (gpm), and pipe O.D. in inches. Therefore:
Velocity=(4×1.5/1000)/(3.1415×(0.25/1000)2)=9.79 ft/s
With this mathematical conclusion we can calculate how long flowing water is within the apparatus depending on the length of embedded serpentine fluid conduit 30. A logical conclusion states that the longer the embedded serpentine fluid conduit 30 is, the longer flowing water is being cooled or heated (as it remains longer in the system). Therefore, in accordance with an important claim of the present invention 10, the embedded serpentine fluid conduit 30 has a great internal surface per volume ratio: the conduit 30 is of a small diameter, reducing its volume, yet of great length to increase its internal surface, there is an increased surface area to cool or heat a comparatively small volume of water. In this preferred embodiment, the embedded serpentine fluid conduit 30 is about 20 feet long. The present invention 10 is not limited to a set length, so long the length of embedded serpentine fluid conduit 30 is sufficient to present an increased internal surface area to volume ratio in order to cool or heat to desirable level water flowing through the apparatus at the applicable velocity. Furthermore, in accordance with another claim of the present invention 10. The length and diameter of embedded serpentine fluid conduit 30 is set to present a decreased volume to fluid velocity ratio. This reduced ratio insures water is cooled or heated to desirable temperature within the time spent inside the apparatus. This time span is set by the velocity of the water. This mathematical conclusion demonstrates embedded serpentine fluid conduit 30 must be of adequately small diameter and sufficient length to fulfill this claim of the present invention 10.

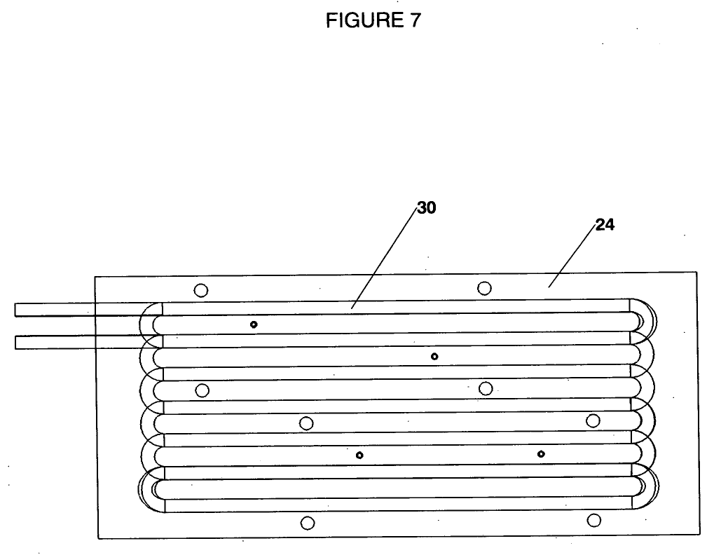

Now turning to FIG. 7, there is shown a plan top see-through view of the thermally conductive metallic medium 24 and embedded serpentine fluid conduit 30. Thermally non-conductive insulating medium 22 is not represented in this view. Circle features in FIG. 7 are cylindrical cavities for securing means placement and temperature control means placement. In accordance with an important claim of the present invention 10, thermally conductive metallic medium 24 has a significantly greater metallic mass compared to the mass of the embedded serpentine fluid conduit 30. This is an important aspect of the apparatus. The combination of thermally conductive metallic medium 24 with thermally non-conductive insulating medium 22 provides a reserve, or pool, or accumulation of cooled or heated thermally conductive mass, also called thermal accumulator. This cooled or heated mass in turns cools or heats embedded serpentine fluid conduit 30 and its content. The greater the mass, the bigger the thermal accumulator's capacity. In the present invention, this mass is significantly greater than the mass of embedded serpentine fluid conduit 30, insuring a supply of flowing water can be cooled or heated on demand.

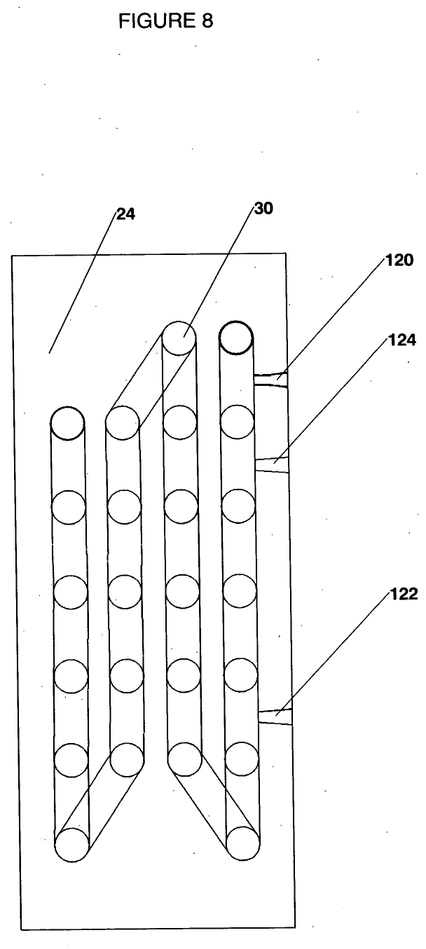

Turning to FIG. 8 there is shown a plan side see-through view of the thermally conductive metallic medium 24 and embedded serpentine fluid conduit 30. As shown in FIG. 8, and in accordance with an important claim of the present invention 10, the embedded serpentine fluid conduit 30's mass is geometrically distributed from optimum thermal distribution. First, the thermally conductive medium 24 completely shrouds the embedded serpentine fluid conduit 30, so that no surface of the conduit except its inlet and outlet is exposed to ambient condition. Second, embedded serpentine fluid conduit 30 is arranged within the metallic medium 24 to maximize the surface of contact between the conduit's wall and the metallic medium. Such configuration is critical to achieve high efficiency required for on demand cooled or heated water. In keeping with the invention's claim, such assembly as shown in FIG. 8 comprises the step of changing or maintaining the thermal condition of a flowing or stagnant fluid for human liquid consumption.

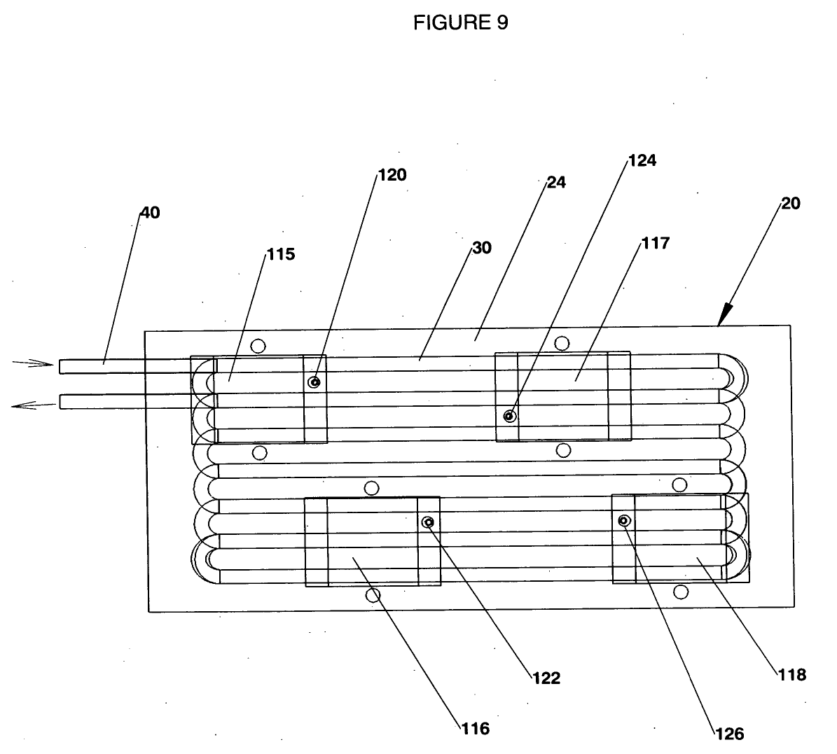

Turning to FIG. 9 a top plan see through assembly view of the thermal accumulator 20 with the thermally conductive metallic medium 24, embedded serpentine fluid conduit 30 visible, and thermally non-conductive insulation medium 22 hidden. Also visible are the cold block spacers 115˜118 which are elements of the network of independently connected heat transfer modules 100. The bottom surfaces of cold block spacers 115˜118 are in direct physical contact with thermally conductive metallic medium 24 the areas of contact between cold block spacers 115˜118 and thermally conductive metallic medium 24 are where the apparatus has the highest heat pumping capacity. In carrying out the present invention's method, the geometrical distribution of cold block spacers 115˜118 is relevant for maximum and reliable heat transfer surface with thermal accumulator 20. In this preferred embodiment, incoming ambient temperature water enters the apparatus via inlet 40, cold block spacer 115 is judiciously located near inlet 40 so that ambient water entering the apparatus is immediately close to a high heat pumping capacity area. This method provides for early changing of the ambient water temperature and also minimizes thermal propagation of ambient water temperature throughout thermal accumulator 20. Additionally, cold block spacer 115 is located on the lower left quadrant of thermal accumulator 20 as shown in FIG. 9. Its surface of contact with thermally conductive metallic medium 24 is judiciously positioned over the first three straight lengths of embedded serpentine fluid conduit 30 as well as over the lower left quadrant set of serpentine fluid conduit's u-turns. Subsequently, cold block spacers 116 and 117 are respectively located on the lower right quadrant and upper left quadrant of thermal accumulator 20. However, still in accordance to the present invention, cold block spacers 116 and 117 are transitioned closer to the middle of thermal accumulator 20 for a maximum and reliable heat transfer surface. in further compliance with the present invention, cold block spacers 116 and 117 also are respectively located over the three farthest right straight lengths and three farthest left straight lengths of embedded serpentine fluid pipe effectively leaving the area over the central straight of embedded serpentine fluid conduit 20 free of cold block spacer, providing a maximum, reliable, and also safe heat transfer surface. This safe aspect of the present invention is detailed further. Cold block spacer 118 is positioned at the upper right quadrant of thermal accumulator 20. Cold block 118 judiciously chosen area is identical to cold block 115 but diametrically opposite. There is also shown in FIG. 9 part of this present invention's process to provide accurate, uniform, and stable temperature control of thermal accumulator 20. Features 120˜126 are cavities in the cold block spacers 115˜118 and thermally conductive metallic medium 24. Cavities 120˜126 are features to judiciously position electronic temperature sensors, not represented in FIG. 9. Temperature control of thermal accumulator 20 is affected by the temperature readings of the electronic temperature sensors. Cavities 120˜126 are positioned close to maximum heat pumping capacity areas for accurate temperature control: maximum heat pumping capacity areas principally determine the temperature of thermal accumulator 20. Cavities 120˜126 are positioned close to each maximum heat pumping capacity areas for uniform temperature control: readings of the electronic temperature sensors are spread over a great surface. Briefly turning back to FIG. 8, cavities 120˜126 (cavity 126 hidden by cavity 122 in this view) are of sufficient depth into thermally conductive metallic medium 24 for stable temperature control: deep enough into thermally conductive medium 24 to measure its temperature free the effects of temperatures of areas other than thermal accumulator 20.

Now turning back to FIG. 9, in accordance with an aspect of the present invention, cavity 120 is positioned near inlet 40 for rapidly detecting variation of temperature in thermal accumulator 20: rapid variation occurs when the apparatus is in use and ambient temperature water enters the system.

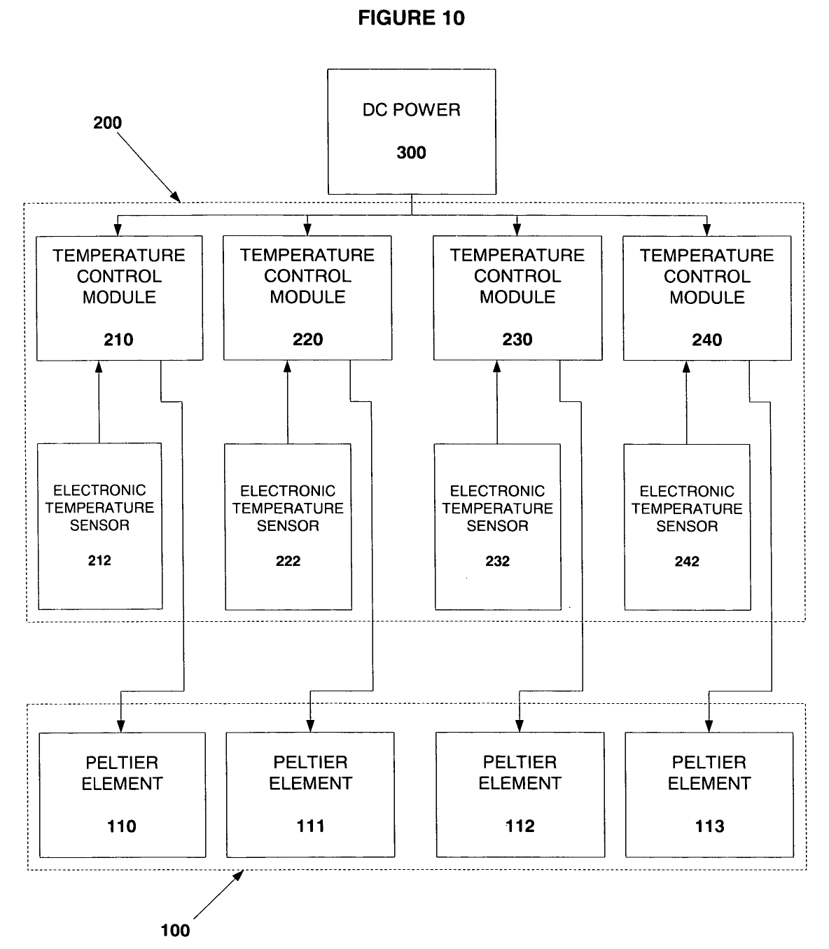

Last turning to FIG. 10. In a preferred embodiment of the present invention, and in accordance with the claims of the present invention, FIG. 10 is a functional diagram of the present invention. DC Power 300 provides power to the apparatus. Temperature control modules 210˜240 and electronic temperature sensors 212˜242 constitute the network of temperature control modules 200. Network of temperature control module 200 independently controls thermoelectric heat transfer modules 100. The present invention is not limited to a single type of temperature control algorithm or technology provided it controls the temperature of thermal accumulator 20 accurately, and is stable and uniform.

In conclusion, the apparatus and process for cooled or heated on demand drinking water relies on the combination of features and methods presented in this detailed description to achieve the functionality set forth for the present invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for Cooled Or Heated On Demand Drinking. Water comprising:
a thermal accumulator with embedded serpentine fluid conduit;
a network of independently controlled thermoelectric heat transfer modules; and
a network of temperature control modules.

2. An apparatus for Cooled Or Heated On Demand Drinking Water as claimed in claim 1 wherein said thermal accumulator is a single die-cast thermally conductive metallic medium free of seams.

3. An apparatus for Cooled Or Heated On Demand Drinking Water as claimed in claim 2 further comprising a thermally non-conductive insulating medium and where said thermally non-conductive medium shrouds all outer surfaces of said single die-cast thermally conductive metallic medium other than surfaces in thermal contact with said thermoelectric heat transfer modules.

4. An apparatus for Cooled Or Heated On Demand Drinking Water as claimed in claim 1 wherein said embedded serpentine fluid conduit is a single continuous thermally conductive metallic pipe.

5. An apparatus for Cooled Or Heated On Demand Drinking Water as claimed in claim 4 wherein said single continuous thermally conductive pipe is free of coupling means other than inlet and outlet coupling means.

6. An apparatus for Cooled Or Heated On Demand Drinking Water as claimed in claim 1 wherein said network of independently controlled thermoelectric heat transfer modules are in physical contact with exposed outer surfaces of said single die-cast thermally conductive metallic medium as claimed in claim 3.

7. An apparatus for Cooled Or Heated On Demand Drinking Water as claimed in claim 1 wherein said network of temperature control modules are electrically connected to said network of independently controlled thermoelectric heat transfer modules and where said network of temperature control modules electronically monitor temperatures of said network of independently controlled thermoelectric heat transfer modules.

8. An apparatus for Cooled Or Heated On Demand Drinking Water as claimed in claim 1 wherein said serpentine fluid conduit is made of metallic material suitable and safe for use with human liquid consumption.

9. A process for An apparatus for Cooled Or Heated On Demand Drinking Water comprising:
a thermal accumulator with embedded serpentine fluid conduit;
a network of independently controlled thermoelectric heat transfer modules; and
a network of temperature control modules.

10. A process for An apparatus for Cooled Or Heated On Demand Drinking Water as claimed in claim 9 wherein said thermal accumulator presents a significantly greater metallic mass when compared to a mass of said embedded serpentine fluid conduit.

11. A process for An apparatus for Cooled Or Heated On Demand Drinking Water as claimed in claim 9 wherein said embedded serpentine fluid conduit presents a great internal surface per volume ratio.

12. A process for An apparatus for Cooled Or Heated On Demand Drinking Water as claimed in claim 9 wherein said embedded serpentine fluid conduit presents an increased volume to fluid velocity ratio.

13. A process for An apparatus for Cooled Or Heated On Demand Drinking Water as claimed in claim 9 further comprising the step of maintaining or changing the thermal condition of a stagnant or flowing fluid for human liquid consumption.

14. A process for An apparatus for Cooled Or Heated On Demand Drinking Water as claimed in claim 10 wherein said embedded serpentine fluid conduit mass is geometrically distributed for optimum thermal distribution throughout said thermal accumulator.

15. A process for An apparatus for Cooled Or Heated On Demand Drinking Water as claimed in claim 9 wherein said network of independently controlled thermoelectric heat transfer modules is geometrically distributed for maximum yet safe and reliable heat transfer surface with said thermal accumulator.

16. A process for An apparatus for Cooled Or Heated On Demand Drinking Water as claimed in claim 9 wherein said network of temperature control modules provide accurate, uniform, and stable temperature control of said thermal accumulator.

17. A process for An apparatus for Cooled Or Heated On Demand Drinking Water as claimed in claim 16 wherein said network of temperature control modules rapidly detects variation of temperature in said thermal accumulator.
